(19) United States
(12) Patent Application Publication
(10) Pub. No.: US 2010/0235924 A1
(43) Pub. Date: Sep. 16, 2010

(54) Secure Personal Medical Process

(76) Inventors: Earl J. Bulot, McLean, VA (US); Edward M. Scheidt, McLean, VA (US)

Correspondence Address: IP STRATEGIES, 12 1/2 WALL STREET, SUITE E, ASHEVILLE, NC, 28801, US

(21) Appl. No.: 12/748,210

(22) Filed: Mar. 26, 2010

Related U.S. Application Data
(63) Continuation-in-part of application No. 11/625,025, filed on Jan. 19, 2007, now abandoned.
(60) Provisional application No. 60/760,623, filed on Jan. 20, 2006.

(51) Int. Cl. G06F 21/00

(52) U.S. Cl. 726/27; 713/182; 713/185

(57) ABSTRACT

A process of accessing and controlling medical information data by a Secure Process that includes two schemas—Medical Access Permission Schema (MAPS) information access system and encryption schema. In particular, the invention relates to a secure process for creating an access control and authentication methodology that identifies specific roles found in the medical field, applies these roles to content attributes, and binds those attributes to secret keys associated with an encryption schema.

### CROSS-REFERENCE TO RELATED APPLICATION

This is a continuation-in-part of U.S. patent application Ser. No. 11/625,025, which was filed on Jan. 19, 2007, which in turn is related to, and claims the benefit under 35 USC §119(e) of U.S. Provisional Application for Patent No. 60/760,623, which was filed on Jan. 20, 2006.

### FIELD OF THE INVENTION

The invention relates to a secure process that includes two schemas—a Medical Access Permission Schema (MAPS) information access system and an encryption schema. In particular, the invention relates to a secure process for creating an access control and authentication methodology that identifies specific roles found in the medical field, applies these roles to content attributes, and binds those attributes to secret keys associated with an encryption schema. A Known Answer computation is included between the specific role and the resultant secret key that is derived from content attributes. The encryption schema is not associated with split key encryption technology but creates a specific relationship among information criteria that can be bound to a key.

### BACKGROUND OF THE INVENTION

A doctor practicing medicine must be concerned with HIPAA and privacy issues of his/her patients and the liability that extends from handling patient information. In the past, the doctor's process for handling patient information and associated data was limited to processing of paper. Currently, some of the patient information and data has been transformed into electronic format. More doctors are relying on electronic forms of handling patient information with the eventuality that many, if not all, medical practices will rely on electronic information and data for their patient information. These two parallel events—doctors moving to electronic information and the security concerns surrounding handling this information—set the stage for an electronic secure process that can address security while extending the process across the information flow from the doctor, hospital related, hospital, EMS services, pharmacy, nursing home, home health care, lab, to the patient and other medical providers.

### BRIEF SUMMARY OF THE INVENTION

According to the an aspect of the invention, a process of accessing and controlling medical information data that can be enforced by encryption keys that are created through a two-step schema process—a Medical Access Permission Schema (MAPS) that identifies specific roles found in the medical field and applies these roles to content attributes, and a second encryption schema that binds these attributes to secret keys associated with an encryption schema. The encryption schema of the secure process is not associated with split key encryption technology but creates a specific relationship among information criteria that can be bound to a key.

The focus of MAPS is to establish a mathematical relationship among entities of a personal medical process that can include the patient, the doctor, a hospital, emergency medical services, and other roles found in the medical field and provide attributes to these entities that are tied to an encryption schema as secret keys. In a different context, MAPS can be seen as a patient—doctor—hospital—and other medical roles—relationship viewed through data that is contributed by all the entity roles. If the focus of the relationship is the patient, the subsequent roles are mathematically a sub-set of the patient—the focus of the relationship can be shifted to the doctor or other entity role with shifts in emphasis of what the focus should be for the information content/data.

The MAPS schema can also include storing at lease a first portion of a specific role on a portable memory device and storing at lease a second portion of a content attribute associated with the specific role on a viewing device that has a common business or usage relationship with the first portion of the content attribute. The two portions—role and content attribute—are mathematically assembled into a resultant number in a process prior to usage so that number can be used as a secret key. It is not until the resultant number is created that that number would be applied an encryption schema. Preferably, the schema is compliant with HIPAA regulations. A Known Answer computation is include between the specific role and the resultant secret key that is derived from content attributes.

The MAPS schema process can be performed on a server connected to at least one node.

The MAPS schema process is based on a unique number assigned to a patent, such as a patient's Social Security Number (SSN), and other unique numbers assigned by medical process entities such as the doctor, a hospital, and other roles. A mathematical relationship is established among the roles and their associated attributes by having the unique numbers multiplied by the first portion of a content attribute. For example, a first portion of a content attribute would be the SSN, whereas a second portion could be a doctor's identifying content attribute number or another medical role-identifying content attributer number. To complete the secure process, the resultant number of the mathematical computation of the different content attribute numbers is used as a secret number for an encryption schema such as used in a Public Key Infrastructure (PKI) or in Constructive Key Management (CKM). In the instance of a PKI usage, the resultant number would be transformed into a mathematical prime or into an elliptical curve. In the instance of a CKM usage, the resultant number would transformed into information attribute.

The mathematical relationship among the entity roles and respective content attribute numbers must be included and in an order-sensitive manner so that the resultant secret key can effectively be re-used in an encryption schema. The resultant number that is encumbered in a key may be used for a period of time concurrent with encryption usage policy. The resultant secret key can take on pseudo-random properties but its functionality is not within the scope of this invention.

The secure process can be established so that different combinations of resulting secret keys can be used to affect access control usages. A patient-centric attribute number with its content attribute numbers can form one secret key that is used with a doctor-centric number with its content attribute numbers to access one set of data; whereas, a different combination or single-centric attribute number can lead access to a separate set of data.

### BRIEF DESCRIPTION OF THE DRAWINGS

FIG. 1 is a block diagram showing an exemplary embodiment of a system utilizing the process of the invention.

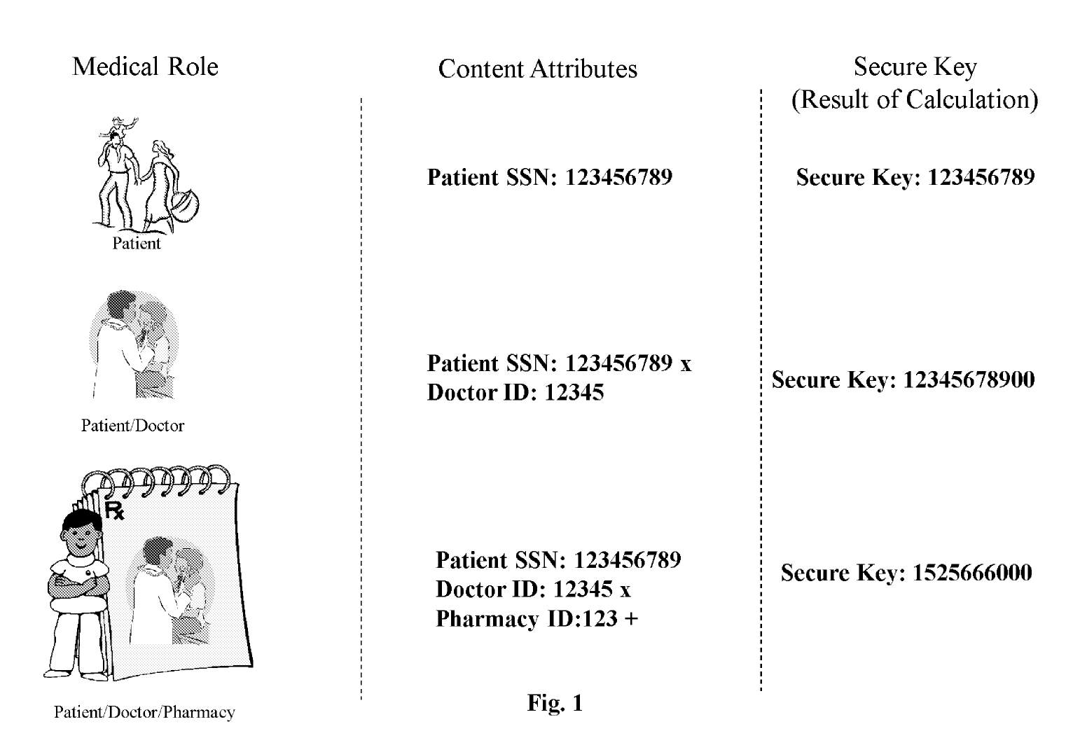

FIG. 2 shows an exemplary general embodiment of a secure process that includes a Medical Access Permission Schema and an associated encryption schema.

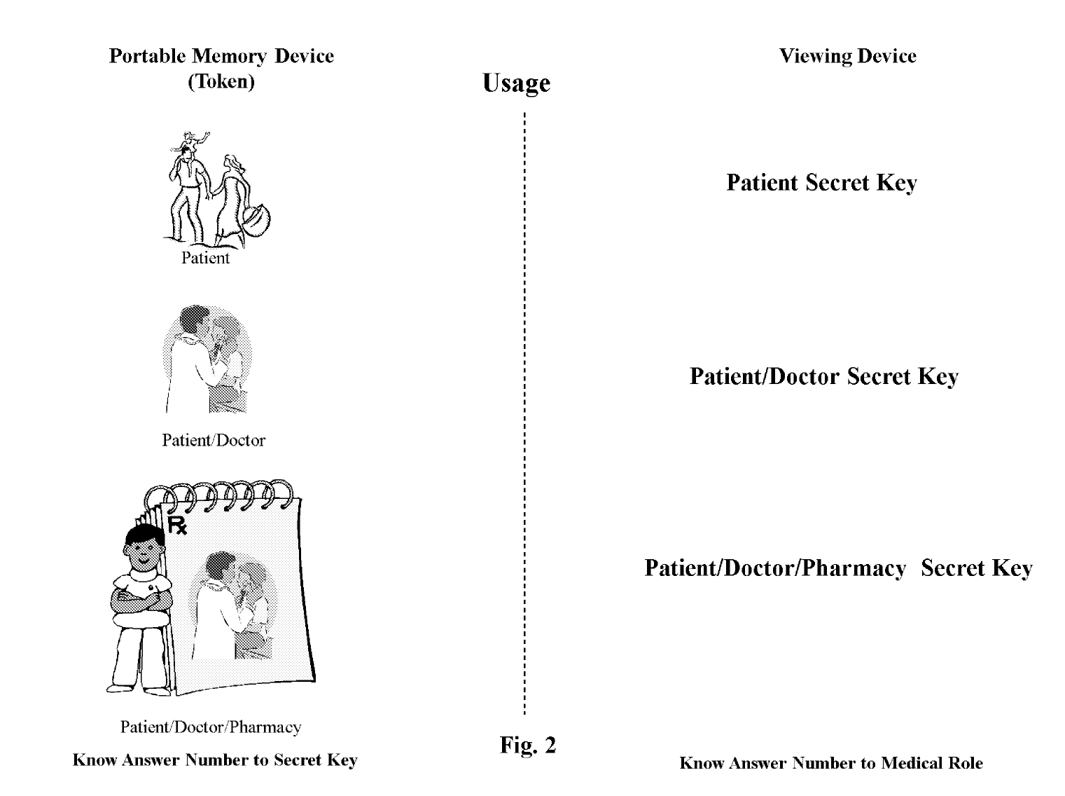

### DETAILED DESCRIPTION OF THE INVENTION

The secure process of the invention creates a permission schema that is related to an encryption schema. A two-step process ensures that a permission relationship is established before that relationship, manifested as a resultant number can be used as a secret key in an encryption schema. Implementing the secret key into a specific encryption schema is outside of the scope of this invention—methodologies for implementing a number into a specific encryption schema may be found in public standards.

The permission schema identifies specific roles found in the medical field and applies these roles to content attributes. The final step is to bind these attributes to secret keys that are associated with an encryption process. A mathematical relationship is established among the roles and their content attributes by having the unique numbers multiplied by the first portion of a content attribute, such as the SSN, and a second portion of a content attribute, which could be a doctor's identifying content attribute number or another medical role content attribute number. The mathematical process among the attribute numbers follows having the unique attribute numbers being multiplied by the first portion of the content attribute, for example a SSN; a second portion as a mathematical multiple of the first portion, and subsequent portions as mathematical multiple of the first portion with each second and subsequent power added together. A Known Answer computation is include between the specific role and the resultant secret key that is derived from content attributes.

The secure process containing the two schema steps is intended to establish a mathematical relationship among entities of a Medical Access Permission Schema (MAPS) for securing personal data. The data can be related the various medical entities such as the patient, the doctor, and others. The secure process can include the patient, the doctor, a hospital, emergency medical services, and other roles found in the medical field and provide attributes to these entities that are tied to secret keys. In short, MAPS can be seen as a patient—doctor—hospital—and other medical roles—relationship viewed through data that is contributed by all the entity roles. If the focus of the relationship is the patient, the subsequent roles are mathematically a sub set of the patient. The focus of the relationship can be shifted to the doctor or other entity role with shifts in emphasis of what the focus should be for the information content/data.

The MAPS schema can also include storing at least a first portion of a specific role on a portable memory device and storing at lease a second portion of a content attribute associated with the specific role on a viewing device that has a common business or usage relationship with the first portion of the content attribute. The two portions—role and content attribute—are mathematically assembled into a resultant number in a process prior to usage so that number can be used as a secret key. It is not until the resultant number is created that that number would be applied an encryption schema. Preferably, the schema is compliant with HIPAA regulations.

The MAPS schema process can be performed on a server connected to at least one node.

Binding the MAPS schema to an encryption schema can lead to having the encryption enforce the security policies associated with access and authentication. The encryption schema can be used to restrict changes to patient information or patient data. HIPAA compliance includes restrictions for modifying data. If the two portions of MAPS are stored in different media such as a first instance on a token and a second instance on a portable memory device, further assurance can be had for the integrity of the patient information.

An objective of the secure process is to include the patient's presence as one means of accessing a medical sensitive data; whereas, there may be other instances that the doctor or other entities create private sensitive medical files/data to which the patient would not normally have access. A further delineation may be for certain files that the patient may only read the file and cannot alter the file—a read-only indicator would be included with the patient attribute content. A separate MAP allocated file may include the content attribute that would allow the patient to read and to write to the file.

From the perspective of the patient: the patient wants to ensure that personal and sensitive information/data is maintained at a personal level within electronic form. The secure data may be stored in many forms such as included in a mobile device or in a PC application. The patient is given a token that includes the entity roles that are assigned by the doctor or other entity. These roles have associated content attributes that have been mathematically mapped to secret keys—these keys may be stored on a medium separate from the token. One example of a patient role is his/her Social Security Number (SSN). A doctor can be assigned a unique number that relates to his/her practice. Other examples of roles would follow policy of the hospital and of other medical entities. The patient can access his/her data by connecting his/her token with a mobile reading device and using the secret key to activate an encryption schema to encrypt or decrypt the private data. A procedural limitation may be included so that the patient can only read his/her information/data, but the patient cannot make changes to the information/data (read-only permission). The use of the secure process preferably is not restricted to the type of data or information.

From the perspective of the doctor: the doctor or the insurance provider can maintain ownership of the secure process. The doctor usually has a relationship with a lab for which the secure process can be extended. One or more hospitals may also have a secure process application. The establishment of who should access the medical records would be determined with the doctor and the patient.

The secure process can be viewed as a controlled information flow process among various entities such as the patient, the doctor, and other medical services. The doctor establishes a medical relationship with the patient that results in patient information and associated data. That information and data is electronically formatted and subsequently processed through the secure process.

If the doctor maintains ownership of the secure process, the doctor can create a token that the patient or other medical entities can use. The intent is for the patient or other medical entity to use the token for return visits and to continually update the relevant information or data while maintaining the integrity of that information or data.

From the perspective of other medical entities: the same or similar secure process that the doctor used can be established by other medical entities. The assignment of the first instance associated with the role and content attributes would be established to conform to access policies and a desired level of access.

Management of Secure Access: A patient visits a doctor for the first time for some form of treatment. As part of the visit, the doctor establishes and electronically documents selected information from the patient in which portions of the information is patient-sensitive. The doctor has established a procedure for maintaining the patient's records so that the patient can have access to read selected information but cannot modify the record. The Social Security Number (SSN) or other identifying information is collected from the patient. The doctor has established a unique number for his own office account. The patient is provided a token that contains encrypted data that has been the result of the Secure Access process and an encryption schema that the process and schema are included in an electronic computing application.

In addition to a token, there are further segments that are contained in the secure access process. A pair of roles has been assigned—one to the patient based on his/her SSN, and one to an identity of the doctor (it could be his/her name or the name of the medical practice). These roles are included with the token. In a separate action of a computing program, the roles are further directly linked to content attribute numbers and these numbers are further introduced as secret keys into an encryption schema. The result is that the keys associated with encryption schema are based on the roles and their respective attributes. Before the content attributes are related as secret keys, a binding is done among the collection of content attributes according to the first instance of the content attribute being a principle number and all other added content attributes being a multiple of the first instance content attribute. The intent is to build a patient-to-doctor relationship as a information access control process that can be mapped to a resultant secret key that would be used in an encryption process. Both the patient and the doctor would retain the key to this relationship; the key would be tagged as patient/doctor to reflect that the key was based on the first instance mathematical model that started with the SSN. A Known Answer computation is include between the specific role and the resultant secret key that is derived from content attributes.

Another key may be created through the same process for a different relationship such as the patient/doctor/pharmacy in which the patient SSN is used as above but in this instance, the doctor and the pharmacy are assigned unique numbers for the content attributes and these attributes are correlated to the roles of doctor and pharmacy. The patient SSN is used as a first instance and the doctor and pharmacy content attribute numbers are added and made a multiple of the first instance. Now the patient, doctor, and pharmacy are all given a copy of the resultant key from the mathematical combination of the three content attribute numbers (the key in this instance may actually be further transformed into another key that was needed to be operable with a designated encryption schema—other math properties may be needed as a resultant number is applied to an encryption schema.)

As mentioned above, the invention is not limited to any particular encryption scheme, and it will be apparent that many standard and proprietary encryption schemes are suitable for application to the process of the invention. For example, the identification, authentication, and encryption schemes disclosed in the following U.S. patents are applicable to the invention, and can be useful in implementing the disclosed processes: U.S. Pat. No. 7,131,009 Multiple factor-based user identification and authentication; U.S. Pat. No. 7,111,173 Encryption process including a biometric unit; U.S. Pat. No. 7,095,852 Cryptographic key split binder for use with tagged data elements; U.S. Pat. No. 7,095,851 Voice and data encryption method using a cryptographic key split combiner; U.S. Pat. No. 7,089,417 Cryptographic information and flow control; U.S. Pat. No. 7,079,653 Cryptographic key split binding process and apparatus; U.S. Pat. No. 7,069,448 Context oriented crypto processing on a parallel processor array; U.S. Pat. No. 7,016,495 Multiple level access system; U.S. Pat. No. 6,845,453 Multiple factor-based user identification and authentication; U.S. Pat. No. 6,754,820 Multiple level access system; U.S. Pat. No. 6,694,433 XML encryption scheme; U.S. Pat. No. 6,684,330 Cryptographic information and flow control; U.S. Pat. No. 6,608,901 Cryptographic key split combiner; U.S. Pat. No. 6,606,386 Cryptographic key split combiner; U.S. Pat. No. 6,549,623 Cryptographic key split combiner; U.S. Pat. No. 6,542,608 Cryptographic key split combiner; U.S. Pat. No. 6,490,680 Access control and authorization system; U.S. Pat. No. 6,266,417 Cryptographic communication process and apparatus; U.S. Pat. No. 6,229,445 RF identification process and apparatus; U.S. Pat. No. 6,075,865 Cryptographic communication process and apparatus; U.S. Pat. No. 5,898,781 Distributed cryptographic object method; U.S. Pat. No. 5,787,173 Cryptographic key management method and apparatus; U.S. Pat. No. 5,680,452 Distributed cryptographic object method; U.S. Pat. No. 5,432,851 Personal computer access control system; U.S. Pat. No. 5,410,599 Voice and data encryption device; U.S. Pat. No. 5,375,169 Cryptographic key management method and apparatus; U.S. Pat. No. 5,369,707 Secure network method and apparatus; U.S. Pat. No. 5,369,702 Distributed cryptographic object method. The disclosures included in these patents are incorporated herein in their entireties.

1. A process of accessing and controlling medical information data enforced by an encryption process, wherein the encryption process includes controlling creation of and access to sensitive data stored on a machine-readable medium, according to a medical access permission schema and an associated encryption schema.

2. The process of claim 1, wherein the medical access encryption schema includes medical roles and associated content attributes that are unique numbers assigned to the roles.

3. The process of claim 2, wherein the medical roles are selected from the group of roles consisting of patient, doctor, hospital, and lab.

4. The process of claim 2, wherein the medical access encryption schema includes
assigning a first permission to a patient, wherein the first permission cannot by itself be used to access the sensitive data, and
assigning a second permission to a data viewing device, wherein a combination of the first and second permissions provides access on the data viewing device to data associated with the patient.

5. The process of claim 4, further comprising storing the first access on a portable memory device.

6. The process of claim 5, wherein the portable memory device is a token.

7. The process of claim 4, further comprising storing the second access on the data viewing device.

8. The process of claim 4, wherein the medical access encryption schema includes assigning the first access to a doctor's office.

9. The process of claim 8, wherein a combination of the first access and the second access provides access to a doctor at the doctor's office to data associated with the patient.

10. The process of claim 4, wherein the medical access encryption schema includes assigning the first access to a lab.

11. The process of claim 10, wherein a combination of the first access and the second access provides access to the lab to data associated with the patient.

12. The process of claim 4, wherein the medical access encryption schema includes assigning the first access to a pharmacy.

13. The process of claim 12, wherein a combination of the first access and the second access provides access to a pharmacist at the pharmacy to data associated with the patient.

14. The process of claim 1, wherein the encryption schema binds a content attribute to a secret encryption key.

15. The process of claim 1, wherein the encryption process is compliant with HIPAA regulations.

16. The process of claim 1, wherein the encryption process is performed on a server connected to at least one node.
